(19) United States
(12) Patent Application Publication
(10) Pub. No.: US 2026/0267767 A1
(43) Pub. Date: Sep. 10, 2026

(54) VIRTUAL IN-VEHICLE SYSTEM CONSTRUCTION METHOD AND VIRTUAL IN-VEHICLE SYSTEM CONSTRUCTION SYSTEM

(71) Applicant: Panasonic Automotive Systems Co., Ltd., Kanagawa (JP)

(72) Inventors: Shintaro MIIKE, Kanagawa (JP); Naoki IKEMOTO, Osaka (JP)

(73) Assignee: Panasonic Automotive Systems Co., Ltd., Kanagawa (JP)

(21) Appl. No.: 19/444,965

(22) Filed: Jan. 9, 2026

(30) Foreign Application Priority Data
Mar. 4, 2025 (JP) 2025-033787

(51) Int. Cl. G06F 11/34; B60W 50/02

(52) U.S. Cl. CPC G06F 11/3457; B60W 50/02

(57) ABSTRACT

A virtual in-vehicle system construction method includes: generating one or more candidates for a combination of one evaluation server among one or more evaluation servers and at least one device server among one or more device servers; measuring a first communication delay between the one evaluation server and the at least one device server of each of the one or more candidates for the combination; determining whether the one or more candidates for the combination include a candidate that satisfies a predetermined criterion for the first communication delay; and constructing a virtual in-vehicle system with the candidate that satisfies the predetermined criterion among the one or more candidates for the combination.

### CROSS REFERENCE TO RELATED APPLICATION

The present application is based on and claims priority of Japanese Patent Application No. 2025-033787 filed on Mar. 4, 2025.

### FIELD

The present disclosure relates to a virtual in-vehicle system construction method, etc. for constructing a virtual in-vehicle system for evaluating an in-vehicle system.

### BACKGROUND

Patent Literature (PTL) 1 discloses a system for generating an estimate for a hardware configuration with performance without excess or shortfall to meet customer requirements, by performing performance evaluations on a virtual system when constructing a system for a customer. The system includes, as a database, the gap between physical performance and virtual performance caused by virtualization overhead, and uses this database to correct performance evaluation results.

### Citation List

### Patent Literature

PTL 1: Japanese Unexamined Patent Application Publication No. 2014-174609

### SUMMARY

The system disclosed in PTL 1 described above can be improved upon.

In view of the above, the present disclosure provides a virtual in-vehicle system construction method, etc., capable of improving upon the above related art.

A virtual in-vehicle system construction method according to the present disclosure includes: generating one or more candidates for a combination of one evaluation server among one or more evaluation servers and at least one device server among one or more device servers, based on information related to the one or more evaluation servers and information related to the one or more device servers, the one or more evaluation servers each including a virtual electronic control unit (ECU) constructed by virtualizing an ECU included in an in-vehicle system, the one or more device servers each connected to a physical device; measuring a first communication delay between the one evaluation server and the at least one device server of each of the one or more candidates for the combination; determining whether the one or more candidates for the combination include a candidate that satisfies a predetermined criterion for the first communication delay; and constructing a virtual in-vehicle system with the candidate that satisfies the predetermined criterion among the one or more candidates for the combination.

A virtual in-vehicle system construction system according to the present disclosure includes: a combination candidate generator that generates one or more candidates for a combination of one evaluation server among one or more evaluation servers and at least one device server among one or more device servers, based on information related to the one or more evaluation servers and information related to the one or more device servers, the one or more evaluation servers each including a virtual electronic control unit (ECU) constructed by virtualizing an ECU included in an in-vehicle system, the one or more device servers each connected to a physical device; a delay measurer that measures a first communication delay between the one evaluation server and the at least one device server of each of the one or more candidates for the combination; a determiner that determines whether the one or more candidates for the combination include a candidate that satisfies a predetermined criterion for the first communication delay; and a constructor that constructs a virtual in-vehicle system with the candidate that satisfies the predetermined criterion among the one or more candidates for the combination.

General and specific aspects disclosed above may be implemented using a system, a method, an integrated circuit, a computer program, or a computer-readable recording medium such as a compact disc read only memory (CD-ROM), or any combination of systems, methods, integrated circuits, computer programs, or computer-readable recording media.

With the virtual in-vehicle system construction method, etc., according to one aspect of the present disclosure, it is possible to improve upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating an application example of a virtual in-vehicle system construction system according to an embodiment.

FIG. 2 is a diagram for explaining an issue that occurs when performing an evaluation of an in-vehicle system using a virtual in-vehicle system.

FIG. 3 is a block diagram illustrating an example of the virtual in-vehicle system construction system according to the embodiment.

FIG. 4A is a diagram illustrating an example of information related to one or more evaluation servers.

FIG. 4B is a diagram illustrating an example of information related to one or more device servers.

FIG. 5 is a flowchart illustrating an example of a virtual in-vehicle system construction method according to the embodiment.

FIG. 6 is a diagram illustrating an example of the virtual in-vehicle system.

FIG. 7 is a diagram illustrating another example of the virtual in-vehicle system.

### DESCRIPTION OF EMBODIMENTS

The technique disclosed in PTL 1 does not take into account the effects on a performance evaluation including peripheral devices that are essential to an in-vehicle system and on an evaluation of a communication delay that occurs when providing a virtual system on the cloud, and thus it is difficult to perform a performance evaluation with high accuracy for evaluation items such as latency which are anticipated in the in-vehicle system. Hereinafter, a virtual in-vehicle system construction method, etc., that enable constructing a virtual in-vehicle system capable of performing a performance evaluation with high accuracy for the evaluation items anticipated in an in-vehicle system will be described.

Hereinafter, embodiments will be described in detail with reference to the Drawings.

It should be noted that the embodiments described below each show a general or specific example. The numerical values, shapes, materials, structural components, the arrangement and connection of the structural components, steps, the processing order of the steps, and so on, indicated in the following embodiments are mere examples, and therefore do not limit the present disclosure.

### Embodiment

Hereinafter, a virtual in-vehicle system construction method and a virtual in-vehicle system construction system according to an embodiment will be described.

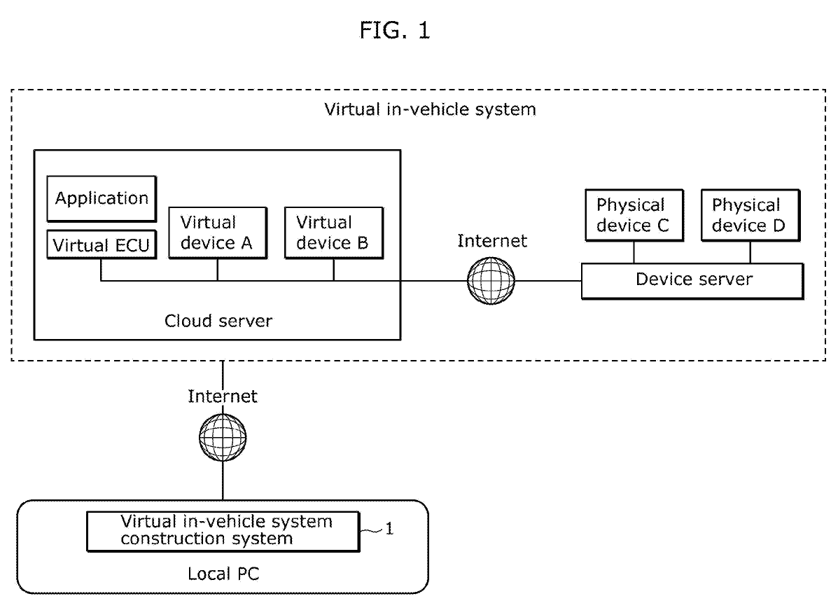

FIG. 1 is a diagram illustrating an application example of virtual in-vehicle system construction system 1 according to the embodiment.

Virtual in-vehicle system construction system 1 is a system for constructing a virtual in-vehicle system. The virtual in-vehicle system is a system resulting from virtualizing an in-vehicle system that is provided in a vehicle, and includes an electric control unit (ECU), etc., that control a physical device such as a camera, a sensor, a speaker, or a display. For example, virtual in-vehicle system construction system 1 is provided in a local personal computer (PC) that performs a performance evaluation of the in-vehicle system. In this case, the user constructs a virtual in-vehicle system using virtual in-vehicle system construction system 1 provided in the local PC, and evaluates, for example, the operating system (OS) or an application included in the in-vehicle system using the constructed virtual in-vehicle system.

The virtual in-vehicle system includes, for example, a cloud server and a device server. The cloud server is an example of the evaluation server in which a virtual ECU resulting from virtualizing the ECU included in the in-vehicle system is constructed. For example, the virtual ECU, the virtual device, and the application are constructed in the cloud server. The virtual device is a device resulting from virtualizing a physical device provided in a vehicle. It should be noted that some physical devices are difficult to virtualize. For this reason, the virtual in-vehicle system includes a device server to which a physical device is connected. The cloud server and device server are connected via the Internet, for example. Using the virtual in-vehicle system enables evaluation utilizing physical devices. FIG. 1 illustrates an example in which virtual devices A and B resulting from virtualizing physical devices that can be virtualized are constructed in the cloud server, and physical devices C and D which are difficult to virtualize are connected to the device server.

It should be noted that the virtual in-vehicle system may include an on-premise server instead of the cloud server. In other words, the on-premises server is also an example of the evaluation server in which a virtual ECU resulting from virtualizing the ECU included in the in-vehicle system is constructed.

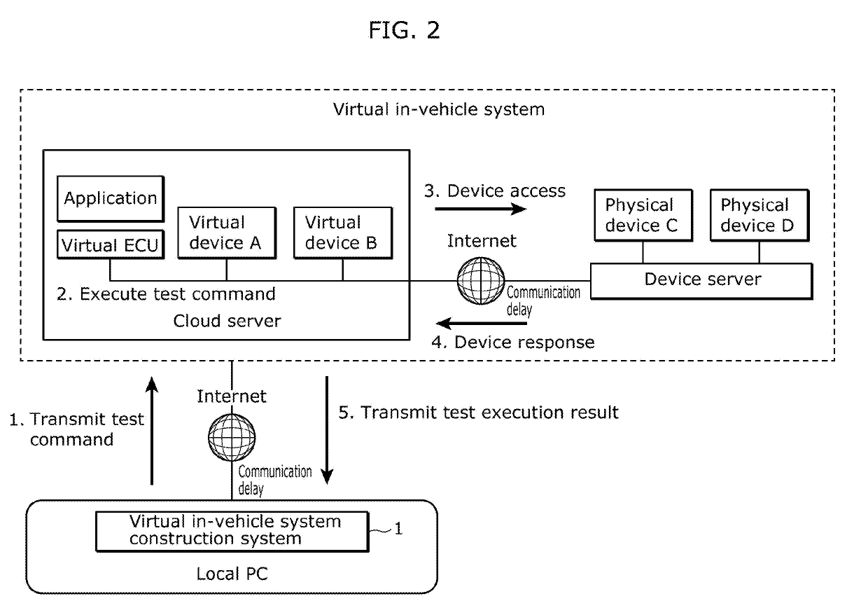

The local PC and the virtual in-vehicle system are connected via the Internet, and the cloud server and device server are also connected via the Internet. When using such a virtual in-vehicle system to perform an evaluation of an in-vehicle system, a communication delay affects the evaluation of the in-vehicle system, making it difficult to perform a performance evaluation with high accuracy. The following describes such an issue with reference to FIG. 2.

FIG. 2 is a diagram for explaining the issue that occurs when performing an evaluation of the in-vehicle system using the virtual in-vehicle system. FIG. 2 illustrates the flow of signals during performing the performance evaluation of the in-vehicle system in an application example of virtual in-vehicle system construction system 1 illustrated in FIG. 1.

First, the local PC transmits a test command to the cloud server. Next, the virtual ECU of the cloud server executes the test command. For example, the evaluation this time requires testing using physical device C or D. The cloud server accesses the device server. The device server performs the test using physical device C or D, and responds to the above-described access made by the cloud server (specifically, the device server transmits a test execution result to the cloud server). The cloud server then transmits the test execution result to the local PC.

In the above-described flow of signals, a communication delay may occur between the local PC and the cloud server, and a communication delay may also occur between the cloud server and the device server. For example, the evaluation of an in-vehicle system includes evaluation related to latency (response speed). For instance, the evaluation of the time taken to display the video of a rear camera on a display after shifting the shift lever of a vehicle to R (reverse) is the evaluation related to latency. If the above-described communication delay occurs during such an evaluation using the virtual in-vehicle system, the effects of the communication delay can cause a latency value to be measured larger than an actual value that should be measured, making it difficult to perform a performance evaluation with high accuracy.

In view of the above, the following describes the virtual in-vehicle system construction method and virtual in-vehicle system construction system 1 which enable constructing a virtual in-vehicle system capable of performing a performance evaluation with high accuracy for evaluation items such as latency that are anticipated in the in-vehicle system.

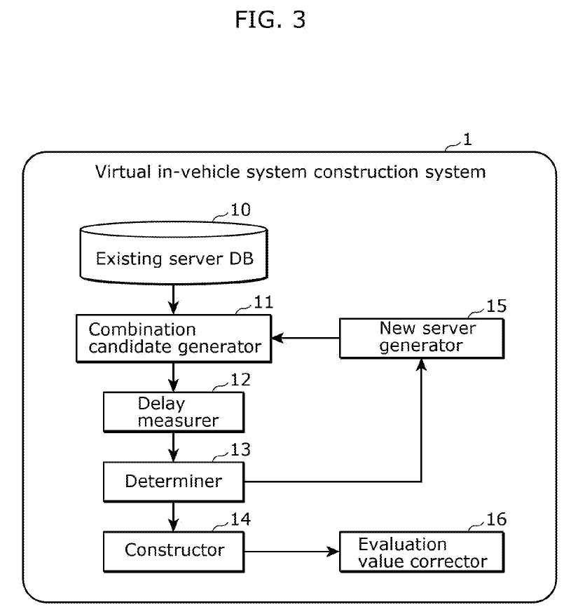

FIG. 3 is a block diagram illustrating an example of virtual in-vehicle system construction system 1 according to the embodiment.

Virtual in-vehicle system construction system 1 includes existing server data base (DB) 10, combination candidate generator 11, delay measurer 12, determiner 13, constructor 14, new server generator 15, and evaluation value corrector 16. Virtual in-vehicle system construction system 1 is a computer including a processor (microprocessor) and memory, for example. Memory is read only memory (ROM), random access memory (RAM), or the like, and is capable of storing a program that is executed by the processor. Combination candidate generator 11, delay measurer 12, determiner 13, constructor 14, new server generator 15, and evaluation value corrector 16 are implemented by, for example, a processor that executes a program stored in the memory. Existing server DB 10 is stored in the memory included in virtual in-vehicle system construction system 1. The memory in which existing server DB 10 is stored may be the same memory as, or a memory different from, the memory in which the above-described program is stored.

As illustrated in FIG. 1, for example, virtual in-vehicle system construction system 1 may be a single-casing computer (e.g., a local PC). Alternatively, virtual in-vehicle system construction system 1 may be a system including a plurality of computers. In addition, for example, virtual in-vehicle system construction system 1 may be a server. It should be noted that the structural components included in virtual in-vehicle system construction system 1 may be disposed in a single server, or may be dispersedly disposed in a plurality of servers. In addition, the structural components included in virtual in-vehicle system construction system 1 may be separately disposed in the local PC and the server.

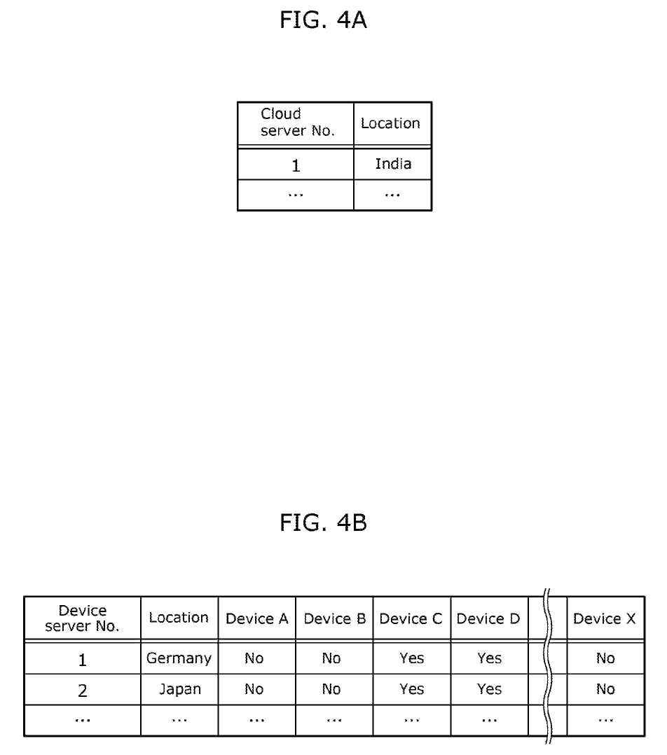

Existing server DB 10 is a database including information related to one or more evaluation servers (e.g., cloud server or on-premise server) in which a virtual ECU resulting from virtualizing the ECU included in the in-vehicle system is constructed, and information related to one or more device servers to which a physical device is connected. Here, the information related to the one or more evaluation servers and the information related to the one or more device servers will be described with reference to FIG. 4A and FIG. 4B.

FIG. 4A is a diagram illustrating an example of the information related to the one or more evaluation servers.

FIG. 4B is a diagram illustrating an example of the information related to the one or more device servers.

Various evaluation servers exist around the world. For example, the information related to the one or more evaluation servers includes information indicating, among the one or more evaluation servers, an evaluation server that can be used for the evaluation of an in-vehicle system. The evaluation server that can be used for the evaluation of an in-vehicle system is a server having a function for evaluating the in-vehicle system. For example, the information related to the one or more evaluation servers may include information related to a geographical location. FIG. 4A indicates, for example, information indicating the evaluation server of cloud server No. 1 that can be used for the evaluation of the in-vehicle system and information indicating that the evaluation server is located in India, as the information related to the one or more evaluation servers. The information related to the one or more evaluation servers may be information related to a plurality of evaluation servers, or may include information indicating a plurality of evaluation servers that can be used for the evaluation of the in-vehicle system. It should be noted that, when only one evaluation server is present that can be used for the evaluation of the in-vehicle system, the information related to the one or more evaluation servers may be information related to the one evaluation server.

Various device servers exist around the world. For example, the information related to the one or more device servers includes information indicating, among the one or more device servers, a device server that can be used for the evaluation of an in-vehicle system. The device server that can be used for the evaluation of an in-vehicle system is a server having a function for evaluating the in-vehicle system. For example, the information related to the one or more device servers may include information related to a geographical location. For example, the information related to the one or more device servers may include information indicating a physical device included. For example, FIG. 4B illustrates information indicating device servers No. 1 and No. 2 that can be used for the evaluation of the in-vehicle system, as the information related to the one or more device servers. Furthermore, it is indicated that the device server of device server No. 1 is located in Germany, and includes physical devices C and D. In addition, it is indicated that the device server of device server No. 2 is located in Japan, and includes physical devices C and D. The information related to the one or more device servers may be information related to a plurality of device servers, or may include information indicating a plurality of device servers that can be used for the evaluation of the in-vehicle system. It should be noted that, when only one device server is present that can be used for the evaluation of the in-vehicle system, the information related to the one or more device servers may be information related to the one device server.

Returning to the explanation of FIG. 3, combination candidate generator 11 generates a candidate for a combination of one evaluation server among the one or more evaluation servers and at least one device server among the one or more device servers, based on existing server DB 10 (specifically, the information related to the one or more evaluation servers and the information related to the one or more device servers). The operation of combination candidate generator 11 will be described later in detail.

Delay measurer 12 measures, for each candidate for the combination generated by combination candidate generator 11, a first communication delay between the evaluation server and the device server. Delay measurer 12 may measure, for each candidate for the combination generated by combination candidate generator 11, a second communication delay between the evaluation server and the local PC. The local PC is one example of a local device that performs an evaluation of the in-vehicle system, using the evaluation server. The operation of delay measurer 12 will be described later in detail.

Determiner 13 determines whether the candidates for the combination generated by combination candidate generator 11 include a candidate that satisfies a predetermined criterion for the first communication delay. At this time, determiner 13 may determine whether the candidates for the combination generated by combination candidate generator 11 include a candidate that satisfies a predetermined criterion for both the first communication delay and the second communication delay. The operation of determiner 13 will be described later in detail.

Constructor 14 constructs a virtual in-vehicle system with the candidate determined to satisfy the predetermined criterion by determiner 13, among the candidates for the combination generated by combination candidate generator 11. The operation of constructor 14 will be described later in detail.

When determiner 13 determines that the candidates for the combination generated by combination candidate generator 11 include no candidate that satisfies the predetermined criterion, new server generator 15 generates a new evaluation server that differs in geographical location from the one or more evaluation servers. The operation of new server generator 15 will be described later in detail.

Evaluation value corrector 16 corrects an evaluation value by subtracting a communication delay that occurs in the virtual in-vehicle system from the evaluation value related to latency that has been evaluated by the virtual in-vehicle system. The operation of evaluation value corrector 16 will be described later in detail.

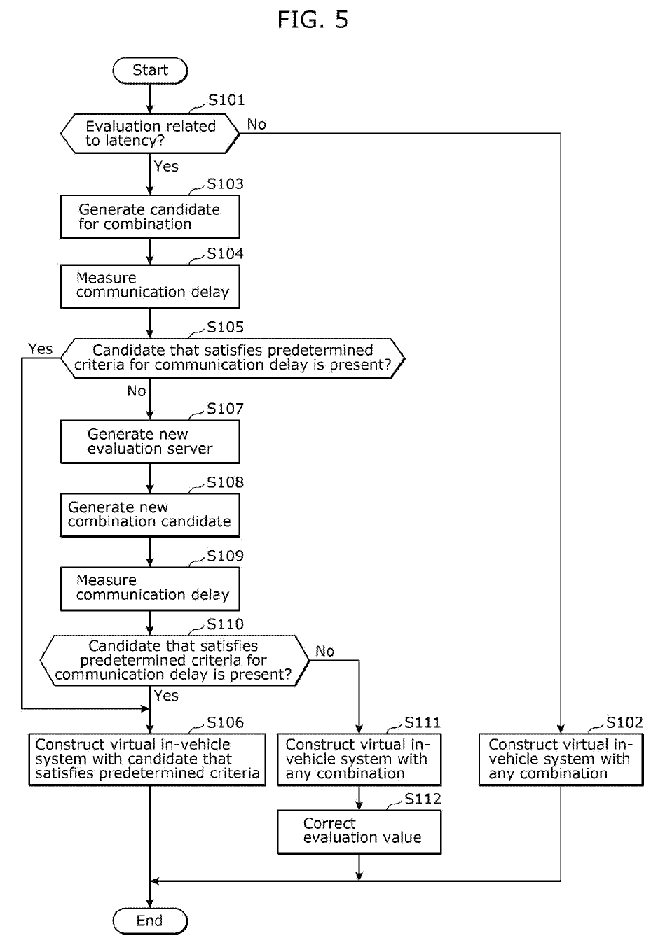

Next, the details of the virtual in-vehicle system construction method will be described with reference to FIG. 5.

FIG. 5 is a flowchart illustrating an example of the virtual in-vehicle system construction method according to the embodiment. It should be noted that the virtual in-vehicle system construction method is a method performed by virtual in-vehicle system construction system 1, and thus FIG. 5 is a flowchart that also illustrates an example of the operation of virtual in-vehicle system construction system 1 according to the embodiment.

First, virtual in-vehicle system construction system 1 receives, for example, an evaluation instruction for the in-vehicle system from a local PC or the like, and determines whether the evaluation instruction received includes an evaluation related to latency (step S101). When it is determined that the evaluation instruction received does not include an evaluation related to latency (No in step S101), constructor 14 constructs a virtual in-vehicle system with one candidate of an optional combination of an evaluation server and a device server (step S102). In an evaluation different from the evaluation related to latency, a communication delay is unlikely to cause an issue. As such, when the evaluation related to latency is not performed, the virtual in-vehicle system can be constructed with an optional candidate.

When it is determined that the evaluation instruction received includes an evaluation related to latency (Yes in step S101), combination candidate generator 11 generates a candidate for a combination of one evaluation server among one or more evaluation servers and at least one device server among one or more device servers, based on the information related to the one or more evaluation servers and the information related to the one or more device servers (step S103: combination candidate generating step). For example, by using the information related to the one or more evaluation servers and the information related to the one or more device servers illustrated in FIG. 4A and FIG. 4B, combination candidate generator 11 generates (i) a candidate for the combination composed of the cloud server (India) and the device server (Germany) and (ii) a candidate for the combination composed of the cloud server (India) and the device server (Japan), from among the cloud server (India) located in India, the cloud server (Germany) located in Germany, and the cloud server (Japan) located in Japan. It should be noted that a candidate for the combination of one evaluation server and a plurality of device servers may be generated. For example, there are instances where a plurality of physical devices are present, and the plurality of physical devices are connected to different device servers. For example, when physical device C out of physical devices C and D is connected to the device server (Germany), and physical device D out of physical devices C and D is connected to the device server (Japan), a candidate for the combination composed of: the cloud server (India); and device server (Germany) and device server (Japan) may be generated.

Next, delay measurer 12 measures, for each candidate for the combination, a first communication delay between the evaluation server and the device server (step S104: delay measuring step). For example, delay measurer 12 measures the first communication delay between the cloud server (India) and the device server (Germany), and measures the first communication delay between the cloud server (India) and the device server (Japan).

It should be noted that, in the delay measuring step (step S104), delay measurer 12 may further measure a second communication delay between the evaluation server of each of the candidates for the combination and a local device that performs an evaluation of the in-vehicle system using the evaluation server. For example, delay measurer 12 may measure the second communication delay between the cloud server (India) and the local PC.

Next, determiner 13 determines whether the candidates for the combination include a candidate that satisfies a predetermined criterion for the first communication delay (step S105: determining step). It should be noted that, in the determining step (step S105), determiner 13 may determine whether the candidates for the combination include a candidate that satisfies a predetermined criterion for both the first communication delay and the second communication delay. Although the predetermined criterion is not specifically limited and is set as appropriate, the first communication delay and the second communication delay that satisfy the predetermined criterion are delays that do not affect the evaluation of latency; that is, small delays. The first communication delay and the second communication delay that do not satisfy the predetermined criterion are delays that affect the evaluation of latency; that is, large delays.

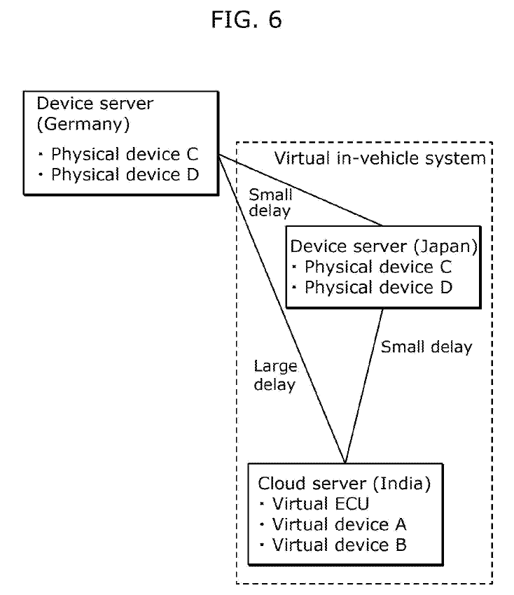

When it is determined that the candidates for the combination include a candidate that satisfies the predetermined criterion for the first communication delay, or that the candidates for the combination include a candidate that satisfies the predetermined criterion for both the first communication delay and the second communication delay (Yes in step S105), constructor 14 constructs a virtual in-vehicle system with a candidate that satisfies the predetermined criterion among the candidates for the combination (step S106: constructing step). Here, an example of the virtual in-vehicle system that is constructed will be described with reference to FIG. 6.

FIG. 6 is a diagram illustrating an example of the virtual in-vehicle system.

For example, FIG. 6 illustrates the case in which the first communication delay between the cloud server (India) and the device server (Germany) does not satisfy the predetermined criterion and has become large, while the first communication delay between the cloud server (India) and the device server (Japan) satisfies the predetermined criterion and has become small. In this case, as illustrated in FIG. 6, constructor 14 constructs a virtual in-vehicle system with the candidate for the combination composed of the cloud server (India) and the device server (Japan) that satisfies the predetermined criterion for the first communication delay. It should be noted that, although not illustrated, when the second communication delay is also measured and the second communication delay between the cloud server (India) and the local PC also satisfies the predetermined criterion, constructor 14 constructs a virtual in-vehicle system with the candidate for the combination composed of the cloud server (India) and the device server (Japan) that satisfies the predetermined criterion for the first communication delay and the second communication delay.

Returning to the explanation of FIG. 5, when it is determined that the candidates for the combination include no candidate that satisfies the predetermined criterion for the first communication delay or when it is determined that the candidates for the combination include no candidate that satisfies the predetermined criterion for both the first communication delay and the second communication delay (No, in step S105), new server generator 15 generates a new evaluation server that differs in geographical location from the one or more evaluation servers included in existing server DB 10 (specifically, information related to the one or more evaluation servers) (step S107: new server generating step).For example, new server generator 15 generates a cloud server (U.S.A.) located in the U.S.A., as a new evaluation server that differs in geographical location from the cloud server (India). The device server requires a physical device, and thus it is difficult to generate a device server in optional countries. On the other hand, the evaluation server in which a virtual ECU is constructed requires no physical device, and thus it is possible to generate an evaluation server such as a cloud server in optional countries.

It should be noted that new server generator 15 may generate a plurality of new evaluation servers.

Next, combination candidate generator 11 generates a candidate for a new combination of a new evaluation server and at least one device server among the one or more device servers (step S108: combination candidate generating step). For example, combination candidate generator 11 generates a candidate for the new combination composed of the cloud server (U.S.A.) and the device server (Germany) and a candidate for the new combination composed of the cloud server (U.S.A.) and the device server (Japan), from among the cloud server (U.S.A.), the device server (Germany), and the device server (Japan). It should be noted that a candidate for the new combination of one new evaluation server and a plurality of device servers may be generated. Furthermore, when a plurality of new evaluation servers are generated, more candidates for the new combination are generated.

Next, delay measurer 12 measures, for each candidate for the new combination, a first communication delay between the new evaluation server and the device server (step S109: delay measuring step). For example, delay measurer 12 measures the first communication delay between the cloud server (U.S.A.) and the device server (Germany), and measures the first communication delay between the cloud server (U.S.A.) and the device server (Japan).

It should be noted that, in the delay measuring step (step S109), delay measurer 12 may further measure a second communication delay between the new evaluation server of each of the candidates for the new combination and a local device that performs an evaluation of the in-vehicle system using the new evaluation server. For example, delay measurer 12 may measure the second communication delay between the cloud server (U.S.A.) and the local PC.

Next, determiner 13 determines whether the candidates for the new combination include a candidate that satisfies a predetermined criterion for the first communication delay (step S110: determining steps). It should be noted that, in the determining step (step S110), determiner 13 may determine whether the candidates for the new combination include a candidate that satisfies a predetermined criterion for both the first communication delay and the second communication delay.

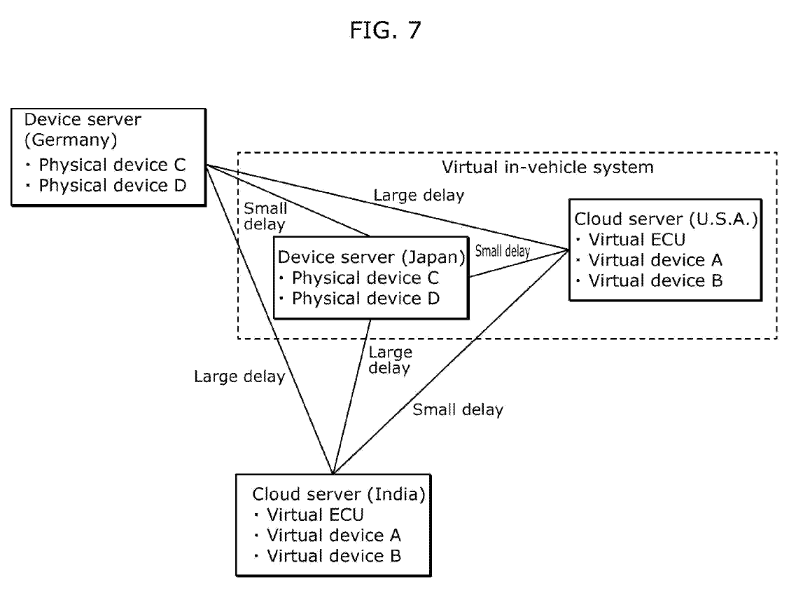

When it is determined that the candidates for the new combination include a candidate that satisfies the predetermined criterion for the first communication delay, or that the candidates for the new combination include a candidate that satisfies the predetermined criterion for both the first communication delay and the second communication delay (Yes in step S110), constructor 14 constructs a virtual in-vehicle system with a candidate that satisfies the predetermined criterion among the candidates for the new combination (step S106: constructing step). Another example of the virtual in-vehicle system that is constructed will be described with reference to FIG. 7.

FIG. 7 is a diagram illustrating another example of the virtual in-vehicle system.

For example, FIG. 7 illustrates the case in which: the first communication delay between the cloud server (India) and the device server (Germany) does not satisfy the predetermined criterion and has become large; and the first communication delay between the cloud server (India) and the device server (Japan) does not satisfy the predetermined criterion and has become large. In this case, for example, a cloud server (U.S.A.) is generated as a new evaluation server. FIG. 7 illustrates the case in which the first communication delay between the cloud server (U.S.A.) and the device server (Germany) does not satisfy the predetermined criterion and has become large, while the first communication delay between the cloud server (U.S.A.) and the device server (Japan) satisfies the predetermined criterion and has become small. In this case, as illustrated in FIG. 7, constructor 14 constructs a virtual in-vehicle system with the candidate for the combination composed of the cloud server (U.S.A.) and the device server (Japan) that satisfies the predetermined criterion for the first communication delay. It should be noted that, although not illustrated, when the second communication delay is also measured and the second communication delay between the cloud server (U.S.A.) and the local PC also satisfies the predetermined criterion, constructor 14 constructs a virtual in-vehicle system with the candidate for the combination composed of the cloud server (U.S.A.) and the device server (Japan) that satisfies the predetermined criterion for the first communication delay and the second communication delay.

As described above, when no candidate that satisfies a predetermined criterion is present, a new evaluation server that differs in geographical location from an existing evaluation server is generated to measure the first communication delay. As a result, the possibility that a candidate that satisfies the predetermined criterion for the first communication delay is obtained is increased. In addition, when the second communication delay is measured, the possibility that a candidate that satisfies the predetermined criterion for the second communication delay is obtained is increased. As a result, the possibility that a virtual in-vehicle system can be constructed with a candidate that satisfies the predetermined criterion is increased.

Returning to the explanation of FIG. 5, when it is determined that candidates for the new combination include no candidate that satisfies the predetermined criterion for the first communication delay or when it is determined that candidates for the new combination include no candidate that satisfies the predetermined criterion for both the first communication delay and the second communication delay (No, in step S110), constructor 14 constructs a virtual in-vehicle system with one candidate of an optional combination of (i) an evaluation server and a device server or (ii) a new evaluation server and a device server (step S111: constructing step).

Evaluation value corrector 16 then corrects an evaluation value by subtracting a communication delay that occurs in the virtual in-vehicle system from the evaluation value related to latency that has been evaluated by the virtual in-vehicle system (step S112: evaluation value correcting step). For example, the first communication delay and the second communication delay are subtracted from the measurements of latency that has been measured in the virtual in-vehicle system constructed with a candidate of an optional combination. It should be noted that, when the cloud server accesses the device server more than once, the second communication delay is subtracted by a total number of accesses. For example, when video is obtained from physical device C that is a camera and the video is displayed on physical device D that is a display, the total number of accesses is two.

In this manner, even when no candidate that satisfies a predetermined criterion is present and a communication delay is occurring in a virtual in-vehicle system constructed with a candidate that does not satisfy the predetermined criterion, since the communication delay is subtracted from the evaluation value related to latency that has been evaluated by the virtual in-vehicle system, it is possible to perform a performance evaluation with high accuracy for the latency.

It should be noted that, in step S111, the one candidate of the optional combination that is used for constructing a virtual in-vehicle system by constructor 14 may be a candidate with the smallest first communication delay, among the candidates for the combination. When the communication delay is large, the error in the communication delay becomes large as well, and thus the error in the evaluation value from which the communication delay has been subtracted becomes large as well. For this reason, by constructing the virtual in-vehicle system using a candidate with the smallest possible communication delay, the error in the evaluation value that has been corrected can also be reduced. As a result, it is possible to perform a performance evaluation for latency with high accuracy.

It should be noted that, even when a virtual in-vehicle system is constructed with a candidate that satisfies the predetermined criterion for the communication delay; that is, when a virtual in-vehicle system is constructed in step S106, the evaluation value may be corrected by subtracting a communication delay that occurs in the virtual in-vehicle system from the evaluation value related to latency that has been evaluated by the virtual in-vehicle system. In this case, even when a some slight communication delay is occurring in the virtual in-vehicle system that has been constructed, the communication delay is subtracted from the evaluation value related to latency that has been evaluated by the virtual in-vehicle system. As a result, it is possible to perform a performance evaluation with high accuracy for the latency.

As described above, a virtual in-vehicle system is constructed with a candidate that satisfies the predetermined criterion for the first communication delay between an evaluation server and a device server; that is, with a candidate for a combination of an evaluation server and a device server with a small communication delay. Accordingly, it is possible to construct a virtual in-vehicle system capable of performing a performance evaluation with high accuracy for the evaluation items (specifically, latency) anticipated in an in-vehicle system. For example, it is possible to perform a latency evaluation for an in-vehicle system including peripheral devices, without using actual equipment (physical device).

Furthermore, a virtual in-vehicle system may be constructed with a candidate that satisfies the predetermined criterion for also the second communication delay between an evaluation server and a local device; that is, a candidate for the combination of an evaluation server and a device server with a small communication delay and also a candidate for the combination of the evaluation server and a local device with a small communication delay. In this case, it is possible to construct a virtual in-vehicle system capable of performing a performance evaluation with higher accuracy for the evaluation items (specifically, latency) anticipated in an in-vehicle system.

### Other Embodiments

Embodiments are described thus far as exemplifications of the technique according to the present disclosure. However, the technique according to the present disclosure is not limited to the foregoing embodiments, and can also be applied to embodiments to which a change, substitution, addition, or omission is executed as necessary. For example, the following variation examples are also included in one embodiment of the present disclosure.

For example, in the foregoing embodiment, although an example has been described in which delay measurer 12 measures the second communication delay, delay measurer 12 need not necessarily measure the second communication delay, and determiner 13 need not necessarily determine whether both the first communication delay and the second communication delay satisfy a predetermined criterion. In other words, in the delay measuring step, it is not necessary to measure the second communication delay, and in the determining step, it is not necessary to determine whether both the first communication delay and the second communication delay satisfy a predetermined criterion.

For example, in the foregoing embodiment, although an example has been described in which virtual in-vehicle system construction system 1 includes new server generator 15, virtual in-vehicle system construction system 1 need not necessarily include new server generator 15. In other words, the virtual in-vehicle system construction method need not necessarily include the new server generating step. In this case, after the determination of No has been made in step S105, the processes from step S107 to step S110 are not performed, and the process in step S111 is performed. More specifically, in step S111, constructor 14 constructs a virtual in-vehicle system with one candidate of an optional combination of an evaluation server and a device server.

For example, in the foregoing embodiment, although an example has been described in which virtual in-vehicle system construction system 1 includes new server generator 16, virtual in-vehicle system construction system 1 need not necessarily include new server generator 16. In other words, the virtual in-vehicle system construction method need not necessarily include the evaluation value correcting step.

For example, the present disclosure may be implemented as a program for causing a computer (processor) to execute the steps included in the virtual in-vehicle system construction method. In addition, the present disclosure can be implemented as a non-transitory computer-readable recording medium such as a compact disc-read only memory (CD-ROM) including the program recorded thereon.

For example, when the present disclosure is implemented by a program (software), each of the steps is performed as a result of the program being executed by utilizing hardware resources such as a CPU, memory, an input and output circuit, etc. of a computer. In other words, each step is executed by the CPU obtaining data from memory or an input and output circuit, etc., performing calculations, and outputting calculation results to memory or input and output circuit, etc.

It should be noted that, in the above-described embodiments, each of the structural components included in virtual in-vehicle system construction system 1 may be configured in the form of a dedicated hardware product, or may be implemented by executing a software program suitable for the structural components. Each of the structural components may be implemented by means of a program executing unit, such as a central processing unit (CPU) and a processor, reading and executing the software program recorded on a recording medium such as a hard disk or a semiconductor memory.

Some or all of the functions of virtual in-vehicle system construction system 1 according to the foregoing embodiments are typically implemented as LSIs which are integrated circuits. They may be implemented as a single chip one-by-one, or as a single chip to include some or all thereof. In addition, the integrated circuit is not limited to an LSI, and it may be implemented as a dedicated circuit or a general-purpose processor. A field programmable gate array (FPGA) that is programmable after an LSI is manufactured or a reconfigurable processor that is capable of reconfiguring connection and settings of circuit cells inside an LSI may be employed.

Furthermore, in the future, with advancement in semiconductor technology, a brand-new technology may replace LSI. The structural components included in virtual in-vehicle system construction system 1 each can be integrated using such a technology.

It should be noted that the present disclosure also includes other forms in which various modifications apparent to those skilled in the art are applied to the embodiments or forms in which structural components and functions in the embodiments are arbitrarily combined within the scope of the present disclosure.

### Note

The descriptions of the embodiments described above disclose the following techniques.

(Technique 1) A virtual in-vehicle system construction method that includes: generating one or more candidates for a combination of one evaluation server among one or more evaluation servers and at least one device server among one or more device servers, based on information related to the one or more evaluation servers and information related to the one or more device servers, the one or more evaluation servers each including a virtual electronic control unit (ECU) constructed by virtualizing an ECU included in an in-vehicle system, the one or more device servers each connected to a physical device; measuring a first communication delay between the one evaluation server and the at least one device server of each of the one or more candidates for the combination; determining whether the one or more candidates for the combination include a candidate that satisfies a predetermined criterion for the first communication delay; and constructing a virtual in-vehicle system with the candidate that satisfies the predetermined criterion among the one or more candidates for the combination.

In this manner, a virtual in-vehicle system is constructed with a candidate that satisfies a predetermined criterion for the first communication delay between an evaluation server and a device server; that is, with a candidate for a combination of an evaluation server and a device server with a small communication delay. Accordingly, it is possible to construct a virtual in-vehicle system capable of performing a performance evaluation with high accuracy for the evaluation items (specifically, latency) anticipated in an in-vehicle system. For example, it is possible to perform a latency evaluation for an in-vehicle system including peripheral devices, without using actual equipment (physical device).

(Technique 2) The virtual in-vehicle system construction method according to Technique 1, in which the measuring further includes measuring a second communication delay between the one evaluation server of each of the one or more candidates for the combination and a local device that performs an evaluation of the in-vehicle system using the one evaluation server, and the determining includes determining whether the one or more candidates for the combination include a candidate that satisfies the predetermined criterion for both the first communication delay and the second communication delay.

In this manner, a virtual in-vehicle system is constructed with a candidate that further satisfies the predetermined criterion for also the second communication delay between an evaluation server and a local device; that is, a candidate for the combination of an evaluation server and a device server with a small communication delay and also a candidate for the combination of the evaluation server and a local device with a small communication delay. As a result, it is possible to construct a virtual in-vehicle system capable of performing a performance evaluation with higher accuracy for the evaluation items anticipated in the in-vehicle system.

(Technique 3) The virtual in-vehicle system construction method according to Technique 1 or 2 further includes: generating a new evaluation server when it is determined that the one or more candidates for the combination include no candidate that satisfies the predetermined criterion, the new evaluation server differing in a geographical location from the one or more evaluation servers. In this virtual in-vehicle system construction method, the generating of the one or more candidates for the combination includes generating one or more candidates for a new combination of the new evaluation server and at least one device server among the one or more device servers.

In this manner, when no candidate that satisfies a predetermined criterion is present, a new evaluation server that differs in geographical location from an existing evaluation server may be generated.

(Technique 4) The virtual in-vehicle system construction method according to Technique 3, in which the measuring includes measuring the first communication delay between the new evaluation server and the at least one device server of each of the one or more candidates for the new combination, and the determining includes determining whether the one or more candidates for the new combination include a candidate that satisfies the predetermined criterion for the first communication delay.

In this manner, when no candidate that satisfies a predetermined criterion is present, a new evaluation server that differs in geographical location from an existing evaluation server is generated to measure the first communication delay, and whether a candidate that satisfies a predetermined criterion for the first communication delay is present is determined. As a result, the possibility that a candidate that satisfies the predetermined criterion for the first communication delay is obtained is increased. As a result, the possibility that a virtual in-vehicle system can be constructed with a candidate that satisfies the predetermined criterion is increased.

(Technique 5) The virtual in-vehicle system construction method according to any one of Technique s 1 to 4 further includes: correcting an evaluation value related to latency evaluated by the virtual in-vehicle system, by subtracting a communication delay occurring in the virtual in-vehicle system from the evaluation value.

In this manner, even when a communication delay is occurring in the virtual in-vehicle system constructed, since the communication delay is subtracted from the evaluation value related to latency that has been evaluated by the virtual in-vehicle system, it is possible to perform an performance evaluation with higher accuracy for the latency

(Technique 6) The virtual in-vehicle system construction method according to any one of Technique s 1 to 4, in which the constructing includes, when it is determined that the one or more candidates for the combination include no candidate that satisfies the predetermined criterion, constructing the virtual in-vehicle system with one candidate among the one or more candidates for the combination, and the virtual in-vehicle system further includes: correcting an evaluation value related to latency evaluated by the virtual in-vehicle system, by subtracting a communication delay occurring in the virtual in-vehicle system from the evaluation value.

In this manner, even when no candidate that satisfies a predetermined criterion is present and a communication delay is occurring in the virtual in-vehicle system constructed with a candidate that does not satisfy the predetermined criterion, since the communication delay is subtracted from the evaluation value related to latency that has been evaluated by the virtual in-vehicle system, it is possible to perform an performance evaluation with high accuracy for the latency.

(Technique 7) The virtual in-vehicle system construction method according to Technique 6, in which the one candidate is a candidate with the first communication delay that is smallest among the one or more candidates for the combination.

When the communication delay is large, the error in the communication delay becomes large as well, and thus the error in the evaluation value from which the communication delay has been subtracted becomes large as well. For this reason, by constructing the virtual in-vehicle system using a candidate with the smallest possible communication delay, the error in the evaluation value that has been corrected can also be reduced. As a result, it is possible to perform a performance evaluation for latency with high accuracy.

(Technique 8) The virtual in-vehicle system construction method according to any one of Techniques 1 to 7, in which the information related to the one or more evaluation servers includes information indicating an evaluation server usable for an evaluation of the in-vehicle system, and the information related to the one or more device servers includes information indicating a device server usable for the evaluation of the in-vehicle system.

In this manner, it is possible to generate a candidate from among the one or more evaluation servers usable for an evaluation of the in-vehicle system and the one or more device servers usable for an evaluation of the in-vehicle system.

(Technique 9) The virtual in-vehicle system construction method according to Technique 8, in which the information related to the one or more device servers includes information indicating the physical device connected to the one or more device servers.

In this manner, it is possible to generate a candidate from among the one or more device servers including a physical device that is the target of evaluation.

(Technique 10) A virtual in-vehicle system construction system that includes: a combination candidate generator that generates one or more candidates for a combination of one evaluation server among one or more evaluation servers and at least one device server among one or more device servers, based on information related to the one or more evaluation servers and information related to the one or more device servers, the one or more evaluation servers each including a virtual electronic control unit (ECU) constructed by virtualizing an ECU included in an in-vehicle system, the one or more device servers each connected to a physical device; a delay measurer that measures a first communication delay between the one evaluation server and the at least one device server of each of the one or more candidates for the combination; a determiner that determines whether the one or more candidates for the combination include a candidate that satisfies a predetermined criterion for the first communication delay; and a constructor that constructs a virtual in-vehicle system with the candidate that satisfies the predetermined criterion among the one or more candidates for the combination.

In this manner, it is possible to provide a virtual in-vehicle system construction method which enables constructing a virtual in-vehicle system capable of performing a performance evaluation with high accuracy for the evaluation items anticipated in the in-vehicle system.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No. 2025-033787 filed on March 4, 2025.

### Industrial Applicability

The present disclosure is applicable to, for example, a system that evaluates an in-vehicle system.

1. A virtual in-vehicle system construction method comprising:
generating one or more candidates for a combination of one evaluation server among one or more evaluation servers and at least one device server among one or more device servers, based on information related to the one or more evaluation servers and information related to the one or more device servers, the one or more evaluation servers each including a virtual electronic control unit (ECU) constructed by virtualizing an ECU included in an in-vehicle system, the one or more device servers each connected to a physical device;
measuring a first communication delay between the one evaluation server and the at least one device server of each of the one or more candidates for the combination;
determining whether the one or more candidates for the combination include a candidate that satisfies a predetermined criterion for the first communication delay; and
constructing a virtual in-vehicle system with the candidate that satisfies the predetermined criterion among the one or more candidates for the combination.

2. The virtual in-vehicle system construction method according to claim 1, wherein
the measuring further includes measuring a second communication delay between the one evaluation server of each of the one or more candidates for the combination and a local device that performs an evaluation of the in-vehicle system using the one evaluation server, and
the determining includes determining whether the one or more candidates for the combination include a candidate that satisfies the predetermined criterion for both the first communication delay and the second communication delay.

3. The virtual in-vehicle system construction method according to claim 1, further comprising:
generating a new evaluation server when it is determined that the one or more candidates for the combination include no candidate that satisfies the predetermined criterion, the new evaluation server differing in a geographical location from the one or more evaluation servers, wherein
the generating of the one or more candidates for the combination includes generating one or more candidates for a new combination of the new evaluation server and at least one device server among the one or more device servers.

4. The virtual in-vehicle system construction method according to claim 3, wherein
the measuring includes measuring the first communication delay between the new evaluation server and the at least one device server of each of the one or more candidates for the new combination, and
the determining includes determining whether the one or more candidates for the new combination include a candidate that satisfies the predetermined criterion for the first communication delay.

5. The virtual in-vehicle system construction method according to claim 1, further comprising:
correcting an evaluation value related to latency evaluated by the virtual in-vehicle system, by subtracting a communication delay occurring in the virtual in-vehicle system from the evaluation value.

6. The virtual in-vehicle system construction method according to claim 1, wherein
the constructing includes, when it is determined that the one or more candidates for the combination include no candidate that satisfies the predetermined criterion, constructing the virtual in-vehicle system with one candidate among the one or more candidates for the combination, and
the virtual in-vehicle system further comprises: correcting an evaluation value related to latency evaluated by the virtual in-vehicle system, by subtracting a communication delay occurring in the virtual in-vehicle system from the evaluation value.

7. The virtual in-vehicle system construction method according to claim 6, wherein
the one candidate is a candidate with the first communication delay that is smallest among the one or more candidates for the combination.

8. The virtual in-vehicle system construction method according to claim 1, wherein
the information related to the one or more evaluation servers includes information indicating an evaluation server usable for an evaluation of the in-vehicle system, and
the information related to the one or more device servers includes information indicating a device server usable for the evaluation of the in-vehicle system.

9. The virtual in-vehicle system construction method according to claim 8, wherein
the information related to the one or more device servers includes information indicating the physical device connected to the one or more device servers.

10. A virtual in-vehicle system construction system comprising:
a combination candidate generator that generates one or more candidates for a combination of one evaluation server among one or more evaluation servers and at least one device server among one or more device servers, based on information related to the one or more evaluation servers and information related to the one or more device servers, the one or more evaluation servers each including a virtual electronic control unit (ECU) constructed by virtualizing an ECU included in an in-vehicle system, the one or more device servers each connected to a physical device;
a delay measurer that measures a first communication delay between the one evaluation server and the at least one device server of each of the one or more candidates for the combination;
a determiner that determines whether the one or more candidates for the combination include a candidate that satisfies a predetermined criterion for the first communication delay; and
a constructor that constructs a virtual in-vehicle system with the candidate that satisfies the predetermined criterion among the one or more candidates for the combination.
